(19) United States
(12) Patent Application Publication
(10) Pub. No.: US 2009/0319903 A1
(43) Pub. Date: Dec. 24, 2009

(54) METHOD AND APPARATUS FOR DISTRIBUTING SYSTEM INFORMATION WINDOWS

(76) Inventor: Seppo M. Alanara, Oulu (FI)

Correspondence Address: DITTHAVONG MORI & STEINER, P.C., 918 Prince St., Alexandria, VA, 22314, US

(21) Appl. No.: 12/144,227

(22) Filed: Jun. 23, 2008

(51) Int. Cl. G06F 3/048

(52) U.S. Cl. 715/733

(57) ABSTRACT

An approach is provided for distributing system information. In one embodiment, the approach provides for determining an overflow condition associated with one of a plurality of system information windows, wherein the overflow condition exists if the one system information window extends to an adjacent transmission period. A next available slot within a communication channel is determined; the one system information window in the overflow condition is assigned to the next available slot. According to another embodiment, the number of system information windows to be transmitted during a longest one of a plurality of repetition periods is determined. Also, the number of system information windows corresponding to a shortest one of the repetition periods within the determined longest repetition period is determined. An average amount of the system information windows is determined based on the determined shortest repetition period and one or more available transmission periods associated with a communication channel of a network. The system information is scheduled for transmission over the communication channel according to the determined average of system information windows.

### BACKGROUND

Radio communication systems, such as a wireless data networks (e.g., Third Generation Partnership Project (3GPP) Long Term Evolution (LTE) systems, spread spectrum systems (such as Code Division Multiple Access (CDMA) networks), Time Division Multiple Access (TDMA) networks, WiMAX (Worldwide Interoperability for Microwave Access), etc.), provide users with the convenience of mobility along with a rich set of services and features. This convenience has spawned significant adoption by an ever growing number of consumers as an accepted mode of communication for business and personal uses. To promote greater adoption, the telecommunication industry, from manufacturers to service providers, has agreed at great expense and effort to develop standards for communication protocols that underlie the various services and features. One area of effort involves control signaling to ensure efficient delivery of data.

### SOME EXEMPLARY EMBODIMENTS

Therefore, there is a need for an approach for providing efficient signaling, which can co-exist with already developed standards and protocols.

According to an exemplary embodiment, a method comprises determining number of system information windows to be transmitted during a longest one of a plurality of repetition periods, and determining number of system information windows corresponding to a shortest one of the repetition periods within the determined longest repetition period. The method also comprises determining average amount of the system information windows based on the determined shortest repetition period and one or more available transmission periods associated with a communication channel of a network. System information is scheduled for transmission over the communication channel according to the determined average of system information windows.

According to another exemplary embodiment, an apparatus comprises logic configured to determine number of system information windows to be transmitted during a longest one of a plurality of repetition periods, and to determine number of system information windows corresponding to a shortest one of the repetition periods within the determined longest repetition period. The logic is further configured to determine average amount of the system information windows based on the determined shortest repetition period and one or more available transmission periods associated with a communication channel of a network. System information is scheduled for transmission over the communication channel according to the determined average of system information windows.

According to another exemplary embodiment, a method comprises determining an overflow condition associated with one of a plurality of system information windows, wherein the overflow condition exists if the one system information window extends to an adjacent transmission period.

According to yet another exemplary embodiment, an apparatus comprises logic configured to determine an overflow condition associated with one of a plurality of system information windows, wherein the overflow condition exists if the one system information window extends to an adjacent transmission period. The logic is further configured to determine a next available slot within a communication channel, and to assign the one system information window in the overflow condition to the next available slot.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of system information, according to an exemplary embodiment;

FIG. 2 is a diagram of a control message specifying scheduling information associated with system information, according to an exemplary embodiment;

FIG. 3 is a flowchart of a process for scheduling transmission of system information (SI), according to an exemplary embodiment;

FIG. 4 is a diagram of failure condition associated with SI-window transmission;

FIGS. 5A-5C are diagrams of exemplary system information scheduling schemes;

FIG. 6 is a flowchart of a process for handling SI-window overflow, according to an exemplary embodiment;

FIG. 7 is a diagram of an exemplary scheduling scheme utilizing the process of FIG. 6, according to an exemplary embodiment;

FIG. 8 is a flowchart of a process for scheduling SI-windows, according to an exemplary embodiment;

FIG. 9 is a diagram of an exemplary scheduling scheme utilizing the process of FIG. 8, according to an exemplary embodiment;

FIGS. 10A-10D are diagrams of communication systems having exemplary long-term evolution (LTE) and E-UTRA (Evolved Universal Terrestrial Radio Access) architectures, in which the system of FIG. 1 can operate to provide resource allocation, according to various exemplary embodiments of the invention;

FIG. 11 is a diagram of hardware that can be used to implement an embodiment of the invention; and

FIG. 12 is a diagram of exemplary components of a user terminal configured to operate in the systems of FIGS. 10A-10D, according to an embodiment of the invention.

### DETAILED DESCRIPTION

An apparatus, method, and software for providing system information (SI) signaling are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a wireless network compliant with the Third Generation Partnership Project (3GPP) Long Term Evolution (LTE) architecture, it is recognized by one of ordinary skill in the art that the embodiments of the inventions have applicability to any type of communication system and equivalent functional capabilities.

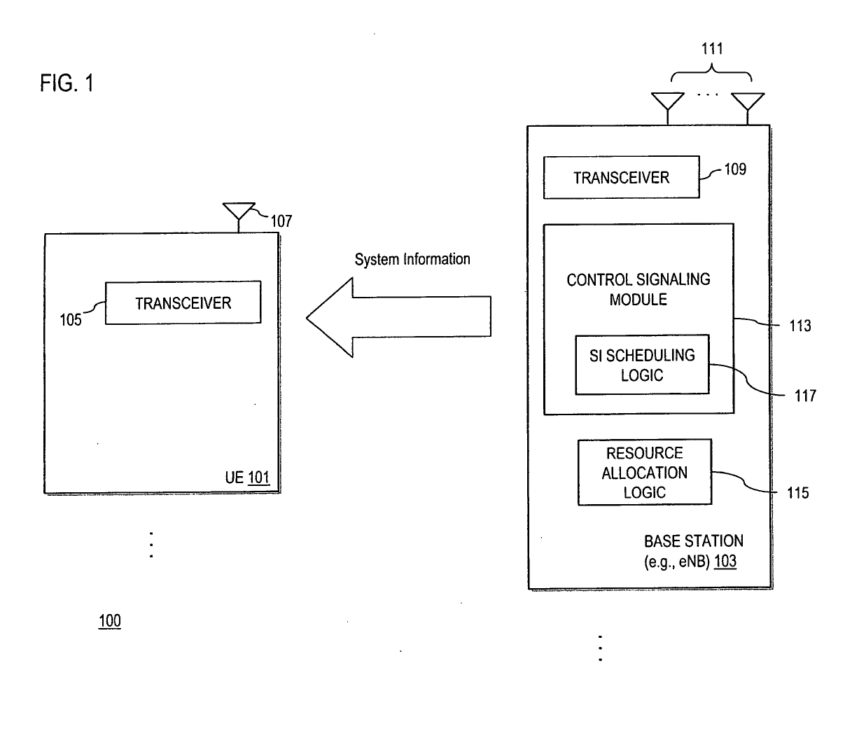

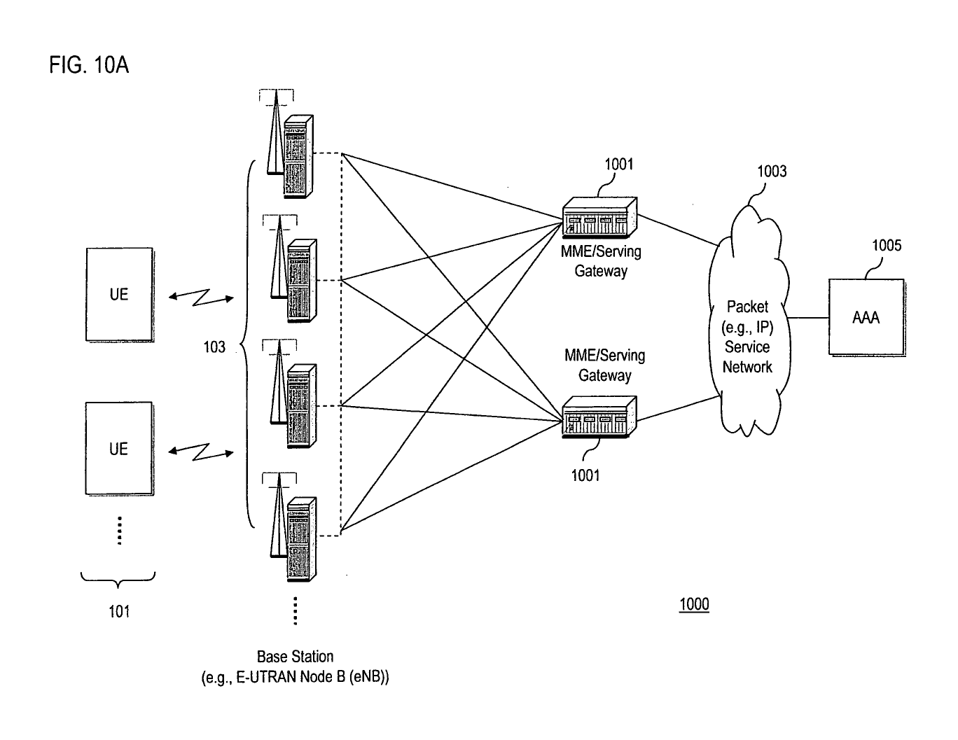

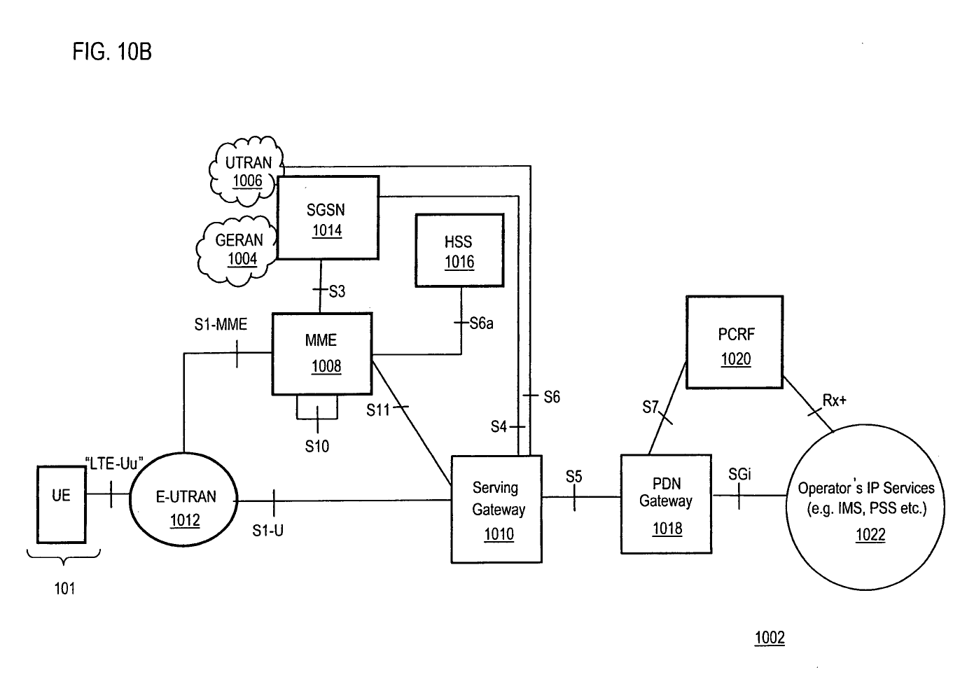

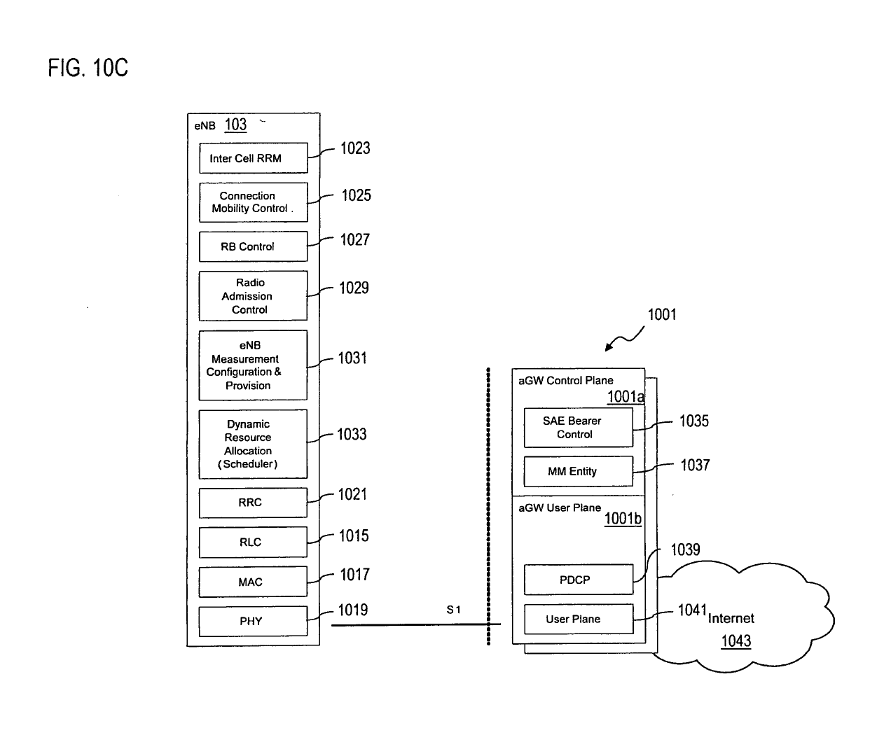

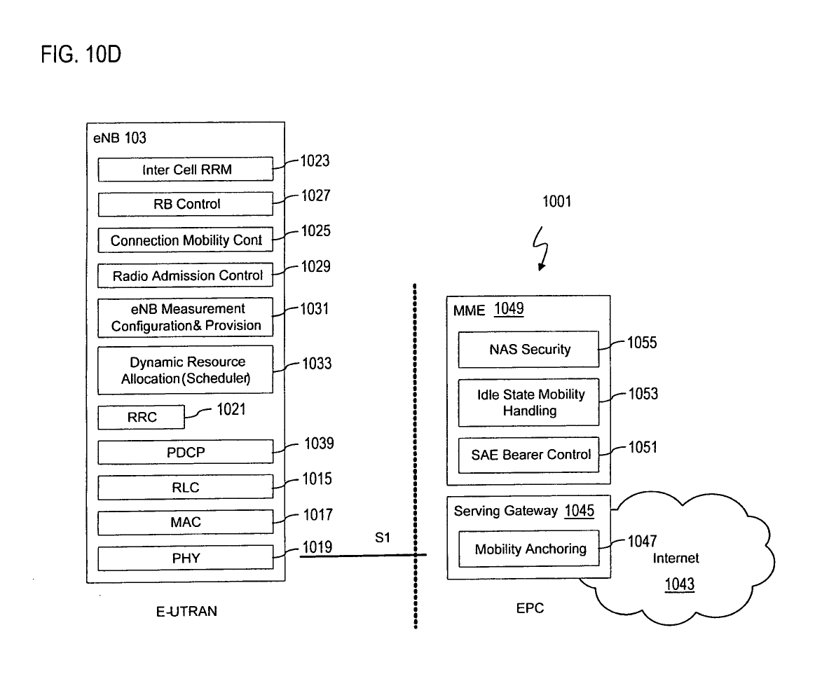

FIG. 1 is a diagram of a communication system capable of system information, according to an exemplary embodiment. As shown in FIG. 1, one or more user equipment (UEs) 101 communicate with a base station 103, which is part of an access network (e.g., 3GPP LTE (or E-UTRAN, etc.). Under the 3GPP LTE architecture (as shown in FIGS. 10A-10D), the base station 103 is denoted as an enhanced Node B (eNB). The UE 101 can be any type of mobile stations, such as handsets, terminals, stations, units, devices, multimedia tablets, Internet nodes, communicators, Personal Digital Assistants (PDAs) or any type of interface to the user (such as “wearable” circuitry, etc.). The UE 101 includes a transceiver 105 and an antenna system 107 that couples to the transceiver 105 to receive or transmit signals from the base station 103. The antenna system 107 can include one or more antennas.

As with the UE 101, the base station 103 employs a transceiver 109, which transmits information to the UE 101. Also, the base station 103 can employ one or more antennas 111 for transmitting and receiving electromagnetic signals. For instance, the Node B 103 may utilize a Multiple Input Multiple Output (MIMO) antenna system 111, whereby the Node B 103 can support multiple antenna transmit and receive capabilities. This arrangement can support the parallel transmission of independent data streams to achieve high data rates between the UE 101 and Node B 103. The base station 103, in an exemplary embodiment, uses OFDM (Orthogonal Frequency Divisional Multiplexing) as a downlink (DL) transmission scheme and a single-carrier transmission (e.g., SC-FDMA (Single Carrier-Frequency Division Multiple Access) with cyclic prefix for the uplink (UL) transmission scheme. SC-FDMA can also be realized using a DFT-S-OFDM principle, which is detailed in 3GGP TR 25.814, entitled “Physical Layer Aspects for Evolved UTRA,” v.1.5.0, May 2006 (which is incorporated herein by reference in its entirety). SC-FDMA, also referred to as Multi-User-SC-FDMA, allows multiple users to transmit simultaneously on different sub-bands.

System 100 provides various channel types: physical channels, transport channels, and logical channels. Physical channels can include a physical downlink shared channel (PDSCH), a dedicated physical downlink dedicated channel (DPDCH), a dedicated physical control channel (DPCCH), etc. The transport channels can be defined by how they transfer data over the radio interface and the characteristics of the data. The transport channels include a broadcast channel (BCH), paging channel (PCH), a dedicated shared channel (DSCH), etc. Other exemplary transport channels are an uplink (UL) Random Access Channel (RACH), Common Packet Channel (CPCH), Forward Access Channel (FACH), Downlink Shared Channel (DLSCH), Uplink Shared Channel (USCH), Broadcast Channel (BCH), and Paging Channel (PCH). A dedicated transport channel is the UL/DL Dedicated Channel (DCH). Each transport channel is mapped to one or more physical channels according to its physical characteristics.

Each logical channel can be defined by the type and required Quality of Service (QoS) of information that it carries. The associated logical channels include, for example, a broadcast control channel (BCCH), a paging control channel (PCCH), Dedicated Control Channel (DCCH), Common Control Channel (CCCH), Shared Channel Control Channel (SHCCH), Dedicated Traffic Channel (DTCH), Common Traffic Channel (CTCH), etc.

The BCCH (Broadcast Control Channel) can be mapped onto both BCH and DSCH. As such, this is mapped to the PDSCH; the time-frequency resource can be dynamically allocated by using L1/L2 control channel (PDCCH). In this case, BCCH (Broadcast Control Channel)-RNTI (Radio Network Temporary Identities) is used to identify the resource allocation information.

Communications between the UE 101 and the base station 103 (and thus, the network) is governed, in part, by control information exchanged between the two entities. Such control information, in an exemplary embodiment, is transported over a control channel on, for example, the downlink from the base station 103 to the UE 101. Accordingly, the base station 103 employs a control signaling module 113. It is recognized that one of the problems related to the control channel in general is that it is desirable to transmit as much information as possible to obtain the greatest flexibility, while reducing the need to provide control signaling as much as possible without losing any (or only marginal) system performance in terms of throughput or efficiency.

To communicate, the mobile station 101 request resources from the network via the base station 103. On the network side, the base station 103 provides resource allocation logic 115 to grant resources for a communication link with the mobile station 101. The communication link, in this example, involves the downlink, which supports traffic from the network to the user, as well as an uplink for transmission of data from the UE 101 to the BS 103. In the LTE, the BS 103 maintains tight control of the transmission resources. That is, the BS 103 will in a controlled manner provide resources for both uplink and downlink transmissions. Typically, these are given on (1) a time-by-time basis (one grant per transmission), or (2) as semi-persistent allocations/grants, where the resources are given for a longer time period.

According to one embodiment, the allocated resources involve physical resource blocks (PRB), which correspond to OFDM symbols, to provide communication between the UE 101 and the base station 103. That is, the OFDM symbols are organized into a number of physical resource blocks that includes consecutive sub-carriers for corresponding consecutive OFDM symbols. To indicate which physical resource blocks (or sub-carrier) are allocated to a UE 101, two exemplary schemes include: (1) bit mapping, and (2) (start, length) by using several bits indicating the start and the length of an allocation block. This signaling of the start and the length will typically use joint coding (i.e., they are signaled using one code word, which contains the information for both parts).

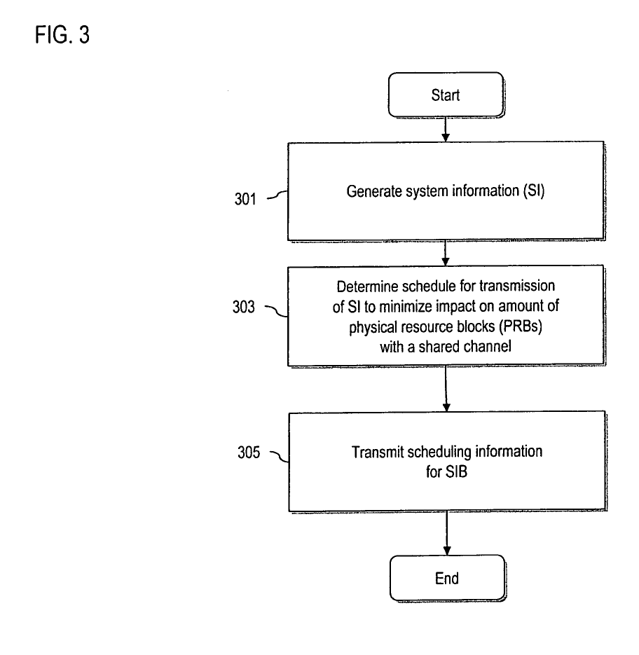

According to certain embodiments, the base station 103 includes system information (SI) scheduling logic 117 to provide system information to the UE 101 over a shared channel to the UE 101. The operation of the logic 117 is more fully described below with respect to FIGS. 3-9.

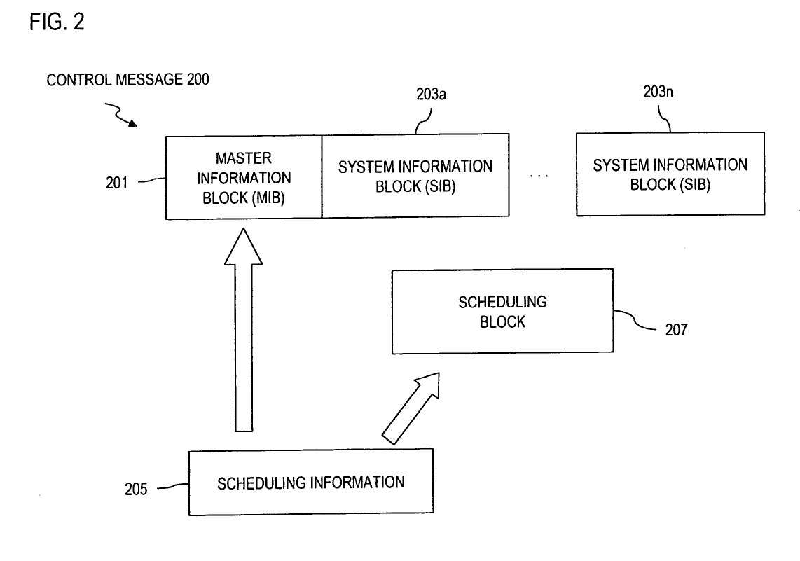

FIG. 2 is a diagram of a control message specifying scheduling information associated with system information, according to an exemplary embodiment. Efficient signaling of system information (SI), such as System Information Blocks (SIB), from the eNB 103 to the UE 101. In one embodiment, such system information can be transmitted to the UE 101 through a control message 200, which can include a Master Information Block (MIB) 201 and one or more System Information Blocks (SIBs) 203a-203n. The MIB 201, for example, provides references and scheduling information 205 for a number of system information blocks 203a-203n. The system information blocks 203a-203n include actual system information. The system information, for example, can indicate usage frequency of a vendor's service. The master information block 201 can specify reference and scheduling information 205 to one or more (e.g., two) scheduling blocks 207, which provide references and scheduling information for additional system information blocks. Scheduling information for a system information block can included in either the master information block or one of the scheduling blocks.

In EUTRAN, scheduling information of System Information Blocks (SIB) 203 can be included in the Master Information Block (MIB) 201 or sent as a separate Scheduling Block (SB) 207. Traditionally, the scheduling information 205 is provided for all SIB's 203a-203n even if this information 205 is not need in the practical User Equipment (UE) software implementations. In practical terms, the repetition (or repeating) rate of many SIB's is usually so frequent that the terminal 101 does not save power by keeping synchronization information of SIB's and possibly powering off the receiver (e.g., transceiver 105) until shortly before the necessary SIB is available on a broadcast channel.

Traditionally, with UTRAN system information (SI) broadcast, the scheduling block 207 is unnecessary large, as it includes scheduling for all SIB's independent of the repetition rate. The UTRAN System Information broadcast structure is detailed in 3GPP TS25.331, entitled “Radio Resource Control (RRC) Protocol Specification,” which is incorporated herein by reference in its entirety. It is recognized that this approach is not efficient with LTE.

The system information are transmitted within an SI-window. In one embodiment, the SI-window is defined as an absolute period during which one SI-message must be transmitted; for example, an SI-window can provide reservation for SI soft repeats, scheduler created gaps, time division duplex (TDD) gaps, paging gaps and unicast MBMS (multimedia broadcast multicast services).

It is recognized that the transmission of system information can affect the allocation of PRBs. Thus, for example, the impact of SI transmissions on the amount of PRBs should be minimized for possible semi-persistent resource allocation, e.g., at 20 ms intervals for real-time applications such as VoIP or any other problematic interval. Additionally, the soft combining repeats may require on small bandwidth cells enablement of full coverage, thereby making it necessary to even out the PRB's needed for BCH.

FIG. 3 is a flowchart of a process for scheduling transmission of system information (SI), according to an exemplary embodiment. Once system information (SI) is generated, the base station 103 determines a schedule for transmission of this information to the UE 101, per steps 301 and 303. Such SI are transported over a channel (e.g., DL-SCH) in the downlink as that of PRBs. As mentioned, the process needs to minimize the effect on PRB allocation. This is especially important in small bandwidth cells. In step 305, the scheduling information corresponding to the system information, e.g., SIBs, is subsequently transmitted. The schedule should provide an even distribution of the SIBs within the DL-SCH.

To better appreciate the above scheduling issue, it is instructive to describe the occurrence of a failure condition for SI-window transmission along with traditional scheduling schemes.

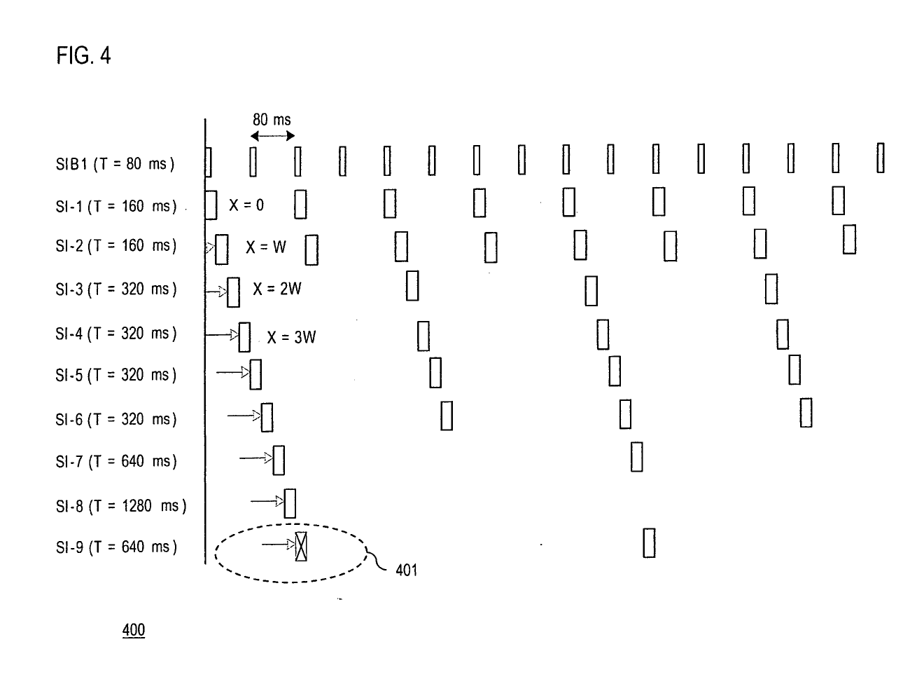

FIG. 4 is a diagram of failure condition associated with SI-window transmission. Graph 400 illustrates what happens when the shortest SI repetition period is not enough to transmit all needed SI windows. For instance, the window for SI-9 does not fit within the repetition period, and thus, cannot be transmitted.

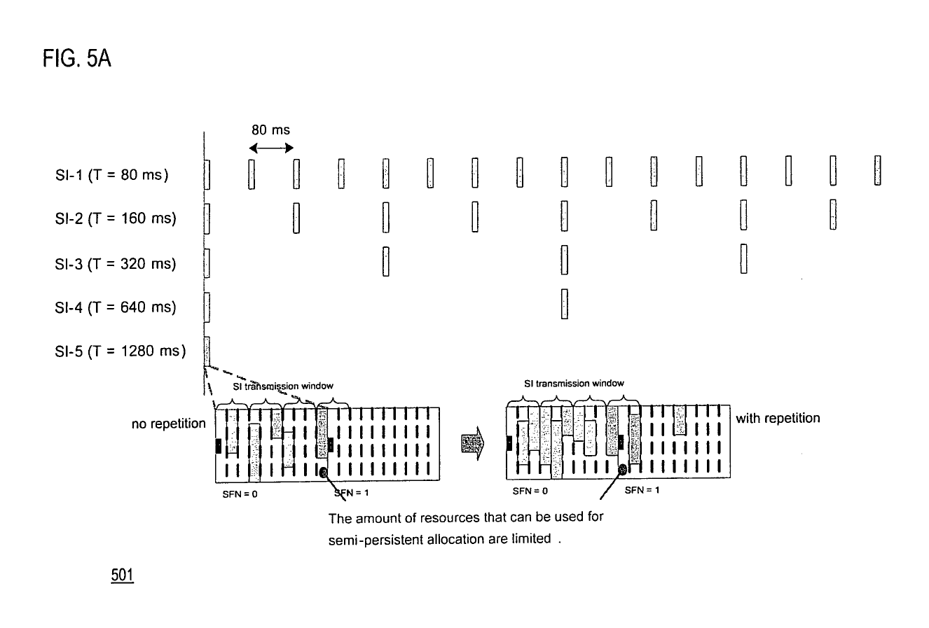

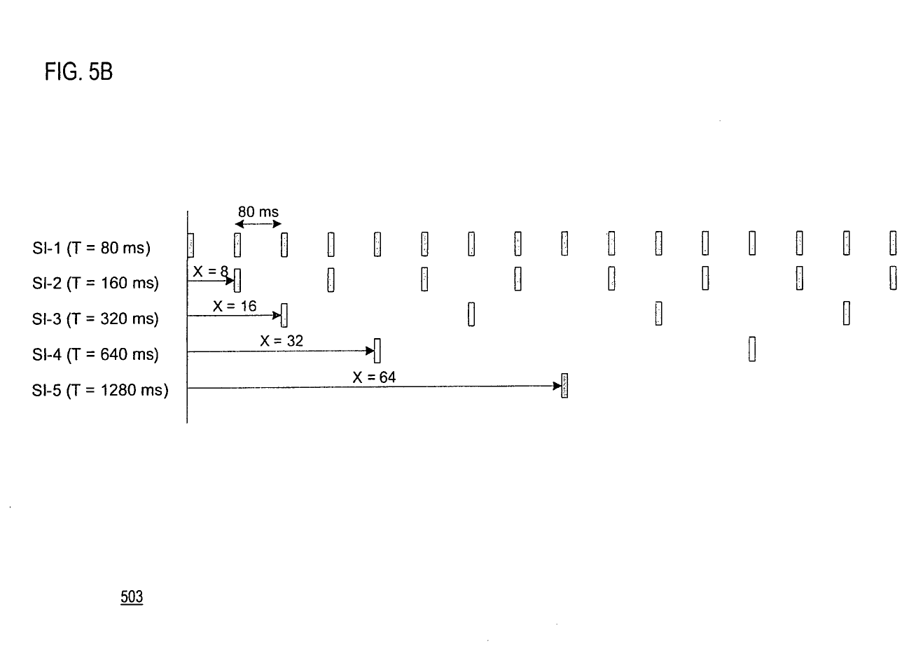

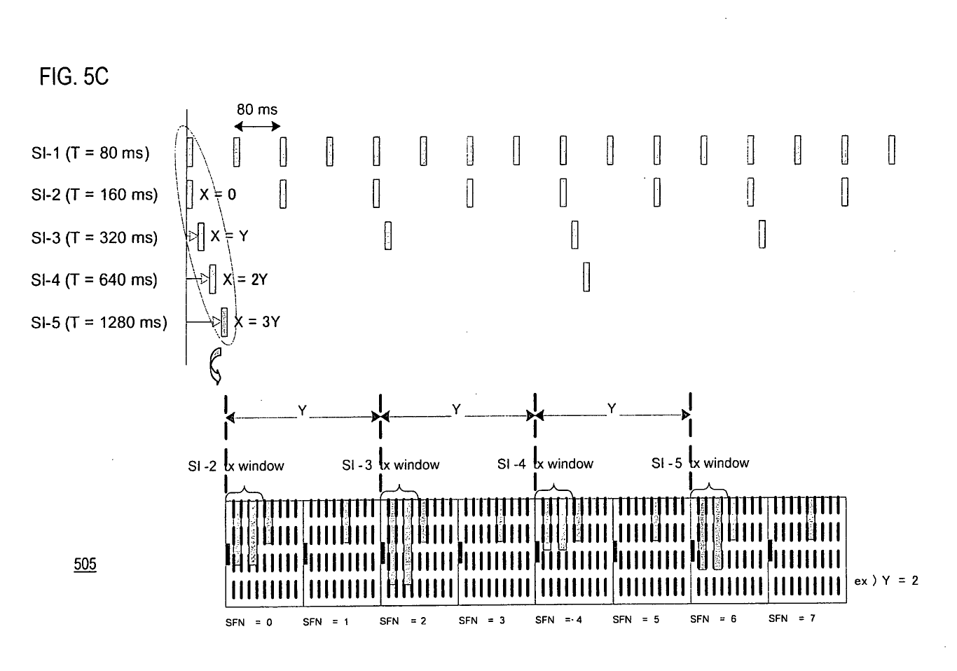

FIGS. 5A-5C are diagrams of exemplary system information scheduling schemes. In particular, FIGS. 5A-5C provide several SI scheduling alternatives for SI-2, 3, . . . . These approaches utilize an offsetting mechanism when determining the radio frames in which SI-2, 3, . . . are scheduled (note that offsetting does not apply to SI-1). Specifically, graph 501 of FIG. 5A involves SI-2, 3, . . . being scheduled at radio frames according to:

SFN mod T=0, Eq. (1)

where T is the periodicity per SI. This will likely introduce significant limitations on semi-persistent resource allocation.

This approach of FIG. 5A is problematic in that all SIBs are transmitted at the repetition period of the SI message or SIB (which has longest repetition period).

In FIG. 5B, graph 503 shows that SI-2, 3, . . . are scheduled at radio frames according to:

SFN mod T=X, Eq. (2)

where X is fixed in the specifications to T/2. This approach has the drawback that if all or many SI messages/SIBs have same repetition period, the distribution cannot operate properly.

In the case illustrated by graph 505 of FIG. 5C, SI-2, 3, . . . are scheduled at radio frames according to:

SFN mod T=0. Eq. (3)

However, if multiple SIs are mapped to the same radio frame, the consecutive SI transmission windows start at certain intervals “Y”, which can be fixed in the specifications (e.g., to 20 ms) or can be configurable. Alternatively, this can be specified as SI-n (n=2, 3, . . . ) being scheduled at:

SFN mod T=(n−2)*Y. Eq. (4)

This arrangement has the drawback that this formula only works when the right side of Eq. (4) does not exceed the T value on the left side of the formula. If the value is exceeded, the formula fails to produce a value that determines the transmission point of the particular SI message. This problem is pronounced, especially for the small bandwidth cells as for those cases in which it may not be possible to concatenate SIBs (depending on SIB length) but to send each SIB in a separate SI message (container message).

Another approach modifies Eq. (4), as follows:

SFN mod T=((n−2)*Y)mod T. Eq. (5)

The approach of Eq. (5) attempts to distribute the system information more evenly. However, this requires an additional parameter which is either fixed in the specification or broadcasted.

As another example, the RRC specification (36.331) provides that when acquiring an SI message, the UE determines the start of the SI-window for the concerned SI message as follows. For the subject SI message, the number n (which corresponds to the order of entry in the list of SI messages configured by schedulingInformation in SystemInformationBlockType1) is determined. Next, the integer value x=(n−1)*w is determined, where w is the si-WindowLength. Also, the SI-window starts at the subframe #a, where a=x mod 10, in the next radio frame for which SFN mod T=FLOOR(x/10), where T is the si-Periodiciry of the concerned SI message. Also, SFN mod T=FLOOR(x/10)+8 may be used instead under certain circumstances.

Moreover, according to the Radio Resource Control (RRC) specification, the UE starts reception of DL-SCH using the SI-RNTI from the start of the SI-window and continues until the end of the SI-window—whose absolute length in time is given by si-WindowLength, or until the SI message was received, excluding the following subframes: subframe #5 in radio frames for which SFN mod 2=0; any MBSFN subframes; and any uplink subframes in TDD. Also, if the SI message was not received by the end of the SI-window, the procedure repeats reception at the next SI-window occasion for the concerned SI message.

From the above description, it is evident that a problem arises when there are not enough SI-windows to send all the system information. To compound this, there is also the challenge of evenly distributing the SI on the DL-SCH.

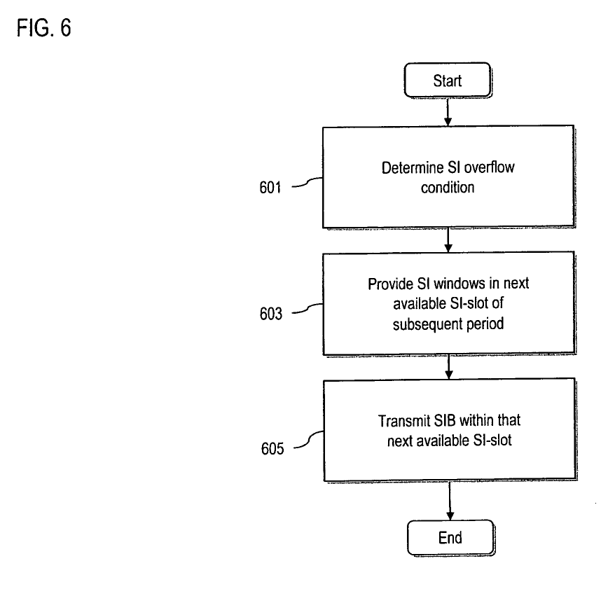

FIG. 6 is a flowchart of a process for handling SI-window overflow, according to an exemplary embodiment. For this process, an overflow situation (whereby the SI-window extends beyond the repetition period) is addressed. In step 601, the SI overflow condition is determined. This process modifies the traditional SI message location function so that the overlap is just added after the SI-windows at the next available unused SI-slot, as in step 603. Next, the SIB is transmitted within that SI-slot, per step 605.

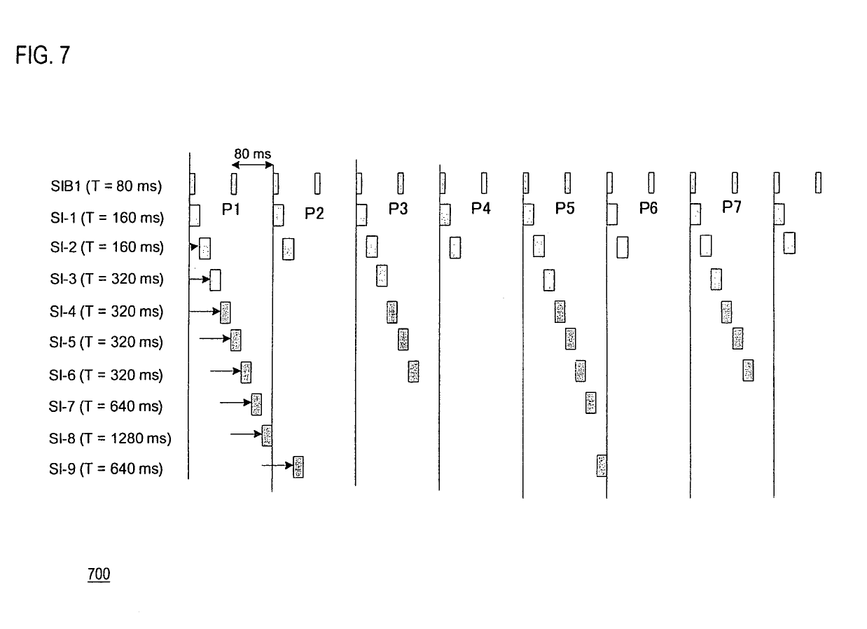

The above process addresses the overflow condition, which is illustrated in FIG. 7.

FIG. 7 is a diagram of an exemplary scheduling scheme utilizing the process of FIG. 6, according to an exemplary embodiment. Graph 700 shows that SI-9 is moved to the period P2.

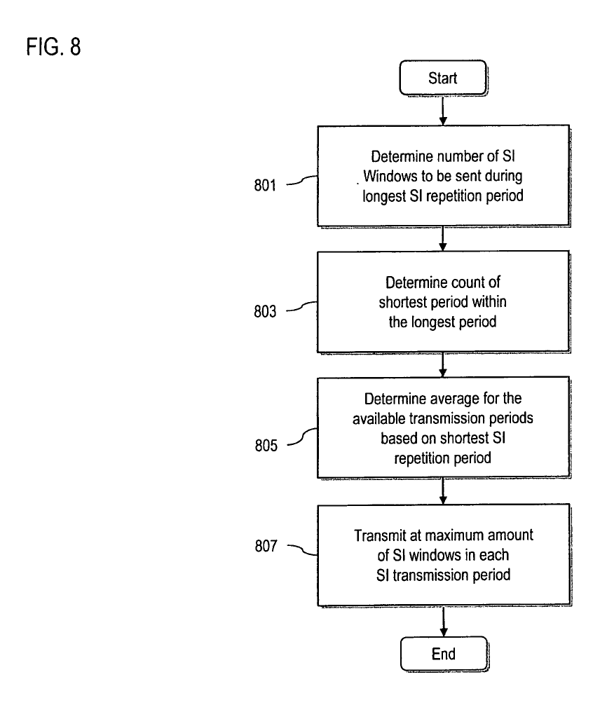

To address the need for evenly distributing the system information, the process of FIG. 8 is now described.

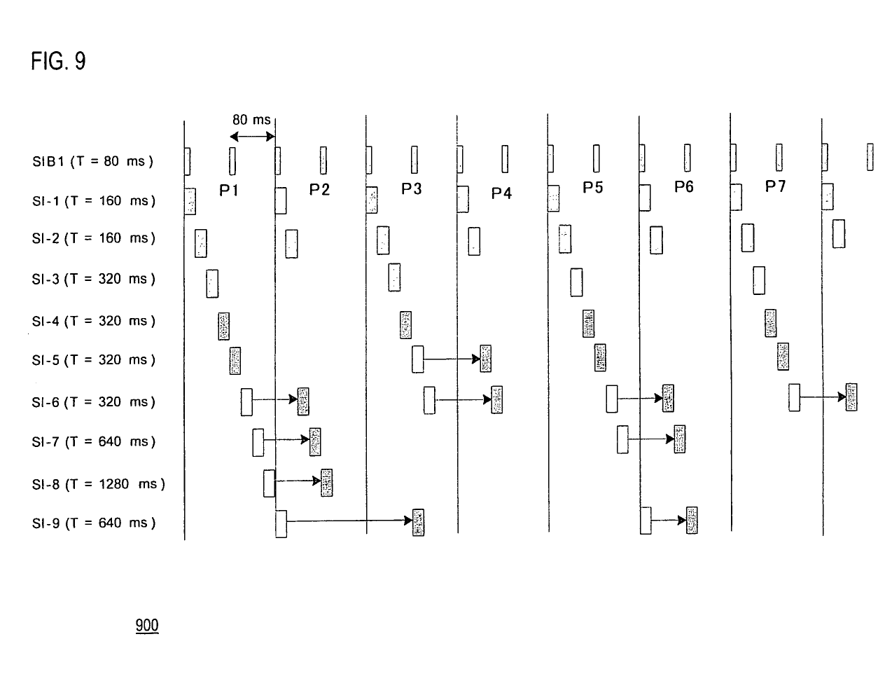

FIG. 8 is a flowchart of a process for scheduling SI-windows, according to an exemplary embodiment. The process first determines, as in step 801, the amount of SI-windows to be sent during the longest SI repetition period in use. That is, the count of SI-windows to be transmitted over the longest SI-period is computed. An exemplary scenario is shown in FIG. 9; in this example, the count is 37 (=8+8+4+4+4+4+2+1+2). Also, the process determines the count of SI-windows associated with the shortest period within the longest period, per step 803. In example case, this is 8 (i.e., 1280/160).

Then, in step 805, an average (denoted “SI_w_ave”) is counted for the available transmission periods based on the shortest SI repetition period in use. The average amount of SI-windows to be transmitted during the shortest SI period; in this example, SI_w_ave=ceiling(37/8)=5. The result yields the maximum amount of SI windows that are sent during any SI transmission period P. Consequently, the process can transmit at maximum the computed average amount SI_W_ave in each transmission period, step 807.

In one embodiment, the above process involves assigning (e.g., by a scheduler) the delayed SI-windows the highest priority for the delayed SI's. In the example of FIG. 9, the SI-6 . . . SI-9 would be sent during the next period followed by SI-i; and the SI-2 would be delayed and sent in the next period.

FIG. 9 is a diagram of an exemplary scheduling scheme utilizing the process of FIG. 8, according to an exemplary embodiment. As shown in graph 900, the first five SIs are sent serially in first 160 ms transmission period using 5 consecutive SI-windows. The four remaining SI-windows are delayed for the next 160 ms SI transmission period so that the SI-windows originally in this SI window (which fit to the SI-window average count in that transmission period) are transmitted first. However SI-9 does not fit, thus it is yet further delayed to the next transmission period.

In certain embodiments, the processes described can provide an even distribution of system information load to the DL-SCH. As mentioned, these processes can be performed within an UMTS terrestrial radio access network (UTRAN) or Evolved UTRAN (E-UTRAN) in 3GPP, as next described.

FIGS. 10A-10D are diagrams of communication systems having exemplary long-term evolution (LTE) architectures, in which the user equipment (UE) and the base station of FIG. 1 can operate, according to various exemplary embodiments of the invention. By way of example (shown in FIG. 10A), a base station (e.g., destination node) and a user equipment (UE) (e.g., source node) can communicate in system 1000 using any access scheme, such as Time Division Multiple Access (TDMA), Code Division Multiple Access (CDMA), Wideband Code Division Multiple Access (WCDMA), Orthogonal Frequency Division Multiple Access (OFDMA) or Single Carrier Frequency Division Multiple Access (FDMA) (SC-FDMA) or a combination of thereof. In an exemplary embodiment, both uplink and downlink can utilize WCDMA. In another exemplary embodiment, uplink utilizes SC-FDMA, while downlink utilizes OFDMA.

The communication system 1000 is compliant with 3GPP LTE, entitled “Long Term Evolution of the 3GPP Radio Technology” (which is incorporated herein by reference in its entirety). As shown in FIG. 10A, one or more user equipment (UEs) communicate with a network equipment, such as a base station 103, which is part of an access network (e.g., WiMAX (Worldwide Interoperability for Microwave Access), 3GPP LTE (or E-UTRAN), etc.). Under the 3GPP LTE architecture, base station 103 is denoted as an enhanced Node B (eNB).

MME (Mobile Management Entity)/Serving Gateways 1001 are connected to the eNBs 103 in a full or partial mesh configuration using tunneling over a packet transport network (e.g., Internet Protocol (IP) network) 1003. Exemplary functions of the MME/Serving GW 1001 include distribution of paging messages to the eNBs 103, termination of U-plane packets for paging reasons, and switching of U-plane for support of UE mobility. Since the GWs 1001 serve as a gateway to external networks, e.g., the Internet or private networks 1003, the GWs 1001 include an Access, Authorization and Accounting system (AAA) 1005 to securely determine the identity and privileges of a user and to track each user's activities. Namely, the MME Serving Gateway 1001 is the key control-node for the LTE access-network and is responsible for idle mode UE tracking and paging procedure including retransmissions. Also, the MME 1001 is involved in the bearer activation/deactivation process and is responsible for selecting the SGW (Serving Gateway) for a UE at the initial attach and at time of intra-LTE handover involving Core Network (CN) node relocation.

A more detailed description of the LTE interface is provided in 3GPP TR 25.813, entitled “E-UTRA and E-UTRAN: Radio Interface Protocol Aspects,” which is incorporated herein by reference in its entirety.

In FIG. 10B, a communication system 1002 supports GERAN (GSM/EDGE radio access) 1004, and UTRAN 1006 based access networks, E-UTRAN 1012 and non-3GPP (not shown) based access networks, and is more fully described in TR 23.882, which is incorporated herein by reference in its entirety. A key feature of this system is the separation of the network entity that performs control-plane functionality (MME 1008) from the network entity that performs bearer-plane functionality (Serving Gateway 1010) with a well defined open interface between them S11. Since E-UTRAN 1012 provides higher bandwidths to enable new services as well as to improve existing ones, separation of MME 1008 from Serving Gateway 1010 implies that Serving Gateway 1010 can be based on a platform optimized for signaling transactions. This scheme enables selection of more cost-effective platforms for, as well as independent scaling of, each of these two elements. Service providers can also select optimized topological locations of Serving Gateways 1010 within the network independent of the locations of MMEs 1008 in order to reduce optimized bandwidth latencies and avoid concentrated points of failure.

As seen in FIG. 10B, the E-UTRAN (e.g., eNB) 1012 interfaces with UE 101 via LTE-Uu. The E-UTRAN 1012 supports LTE air interface and includes functions for radio resource control (RRC) functionality corresponding to the control plane MME 1008. The E-UTRAN 1012 also performs a variety of functions including radio resource management, admission control, scheduling, enforcement of negotiated uplink (UL) QoS (Quality of Service), cell information broadcast, ciphering/deciphering of user, compression/decompression of downlink and uplink user plane packet headers and Packet Data Convergence Protocol (PDCP).

The MME 1008, as a key control node, is responsible for managing mobility UE identifies and security parameters and paging procedure including retransmissions. The MME 1008 is involved in the bearer activation/deactivation process and is also responsible for choosing Serving Gateway 1010 for the UE 101. MME 1008 functions include Non Access Stratum (NAS) signaling and related security. MME 1008 checks the authorization of the UE 101 to camp on the service provider's Public Land Mobile Network (PLMN) and enforces UE 101 roaming restrictions. The MME 1008 also provides the control plane function for mobility between LTE and 2G/3G access networks with the S3 interface terminating at the MME 1008 from the SGSN (Serving GPRS Support Node) 1014.

The SGSN 1014 is responsible for the delivery of data packets from and to the mobile stations within its geographical service area. Its tasks include packet routing and transfer, mobility management, logical link management, and authentication and charging functions. The S6a interface enables transfer of subscription and authentication data for authenticating/authorizing user access to the evolved system (AAA interface) between MME 1008 and HSS (Home Subscriber Server) 1016. The S10 interface between MMEs 1008 provides MME relocation and MME 1008 to MME 1008 information transfer. The Serving Gateway 1010 is the node that terminates the interface towards the E-UTRAN 1012 via S1-U.

The S1-U interface provides a per bearer user plane tunneling between the E-UTRAN 1012 and Serving Gateway 1010. It contains support for path switching during handover between eNBs 103. The S4 interface provides the user plane with related control and mobility support between SGSN 1014 and the 3GPP Anchor function of Serving Gateway 1010.

The S12 is an interface between UTRAN 1006 and Serving Gateway 1010. Packet Data Network (PDN) Gateway 1018 provides connectivity to the UE 101 to external packet data networks by being the point of exit and entry of traffic for the UE 101. The PDN Gateway 1018 performs policy enforcement, packet filtering for each user, charging support, lawful interception and packet screening. Another role of the PDN Gateway 1018 is to act as the anchor for mobility between 3GPP and non-3GPP technologies such as WiMax and 3GPP2 (CDMA 1× and EvDO (Evolution Data Only)).

The S7 interface provides transfer of QoS policy and charging rules from PCRF (Policy and Charging Role Function) 1020 to Policy and Charging Enforcement Function (PCEF) in the PDN Gateway 1018. The SGi interface is the interface between the PDN Gateway and the operator's IP services including packet data network 1022. Packet data network 1022 may be an operator external public or private packet data network or an intra operator packet data network, e.g., for provision of IMS (IP Multimedia Subsystem) services. Rx+ is the interface between the PCRF and the packet data network 1022.

As seen in FIG. 10C, the eNB 103 utilizes an E-UTRA (Evolved Universal Terrestrial Radio Access) (user plane, e.g., RLC (Radio Link Control) 1015, MAC (Media Access Control) 1017, and PHY (Physical) 1019, as well as a control plane (e.g., RRC 1021)). The eNB 103 also includes the following functions: Inter Cell RRM (Radio Resource Management) 1023, Connection Mobility Control 1025, RB (Radio Bearer) Control 1027, Radio Admission Control 1029, eNB Measurement Configuration and Provision 1031, and Dynamic Resource Allocation (Scheduler) 1033.

The eNB 103 communicates with the aGW 1001 (Access Gateway) via an S1 interface. The aGW 1001 includes a User Plane 1001a and a Control plane 1001b. The control plane 1001b provides the following components: SAE (System Architecture Evolution) Bearer Control 1035 and MM (Mobile Management) Entity 1037. The user plane 1001b includes a PDCP (Packet Data Convergence Protocol) 1039 and a user plane functions 1041. It is noted that the functionality of the aGW 1001 can also be provided by a combination of a serving gateway (SGW) and a packet data network (PDN) GW. The aGW 1001 can also interface with a packet network, such as the Internet 1043.

In an alternative embodiment, as shown in FIG. 10D, the PDCP (Packet Data Convergence Protocol) functionality can reside in the eNB 103 rather than the GW 1001. Other than this PDCP capability, the eNB functions of FIG. 10C are also provided in this architecture.

In the system of FIG. 10D, a functional split between E-UTRAN and EPC (Evolved Packet Core) is provided. In this example, radio protocol architecture of E-UTRAN is provided for the user plane and the control plane. A more detailed description of the architecture is provided in 3GPP TS 86.300.

The eNB 103 interfaces via the S1 to the Serving Gateway 1045, which includes a Mobility Anchoring function 1047. According to this architecture, the MME (Mobility Management Entity) 1049 provides SAE (System Architecture Evolution) Bearer Control 1051, Idle State Mobility Handling 1053, and NAS (Non-Access Stratum) Security 1055.

One of ordinary skill in the art would recognize that the processes for performing cell searches may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below.

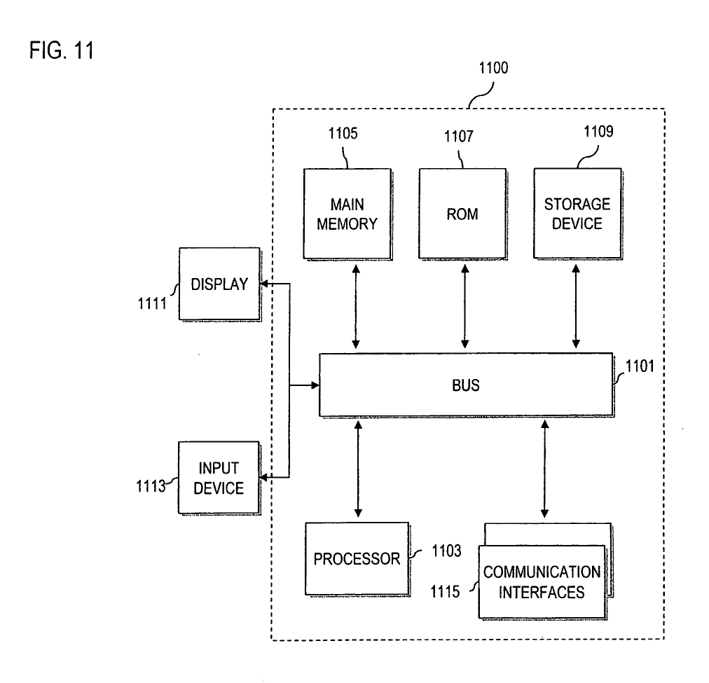

FIG. 11 illustrates exemplary hardware upon which various embodiments of the invention can be implemented. A computing system 1100 includes a bus 1101 or other communication mechanism for communicating information and a processor 1103 coupled to the bus 1101 for processing information. The computing system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computing system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computing system 1100 may be coupled via the bus 1101 to a display 1111, such as a liquid crystal display, or active matrix display, for displaying information to a user. An input device 1113, such as a keyboard including alphanumeric and other keys, may be coupled to the bus 1101 for communicating information and command selections to the processor 1103. The input device 1113 can include a cursor control, such as a mouse, a trackball, or cursor direction keys, for communicating direction information and command selections to the processor 1103 and for controlling cursor movement on the display 1111.

According to various embodiments of the invention, the processes described herein can be provided by the computing system 1100 in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1100 also includes at least one communication interface 1115 coupled to bus 1101. The communication interface 1115 provides a two-way data communication coupling to a network link (not shown). The communication interface 1115 sends and receives electrical, electromagnetic, or optical signals that carry digital data streams representing various types of information. Further, the communication interface 1115 can include peripheral interface devices, such as a Universal Serial Bus (USB) interface, a PCMCIA (Personal Computer Memory Card International Association) interface, etc.

The processor 1103 may execute the transmitted code while being received and/or store the code in the storage device 1109, or other non-volatile storage for later execution. In this manner, the computing system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

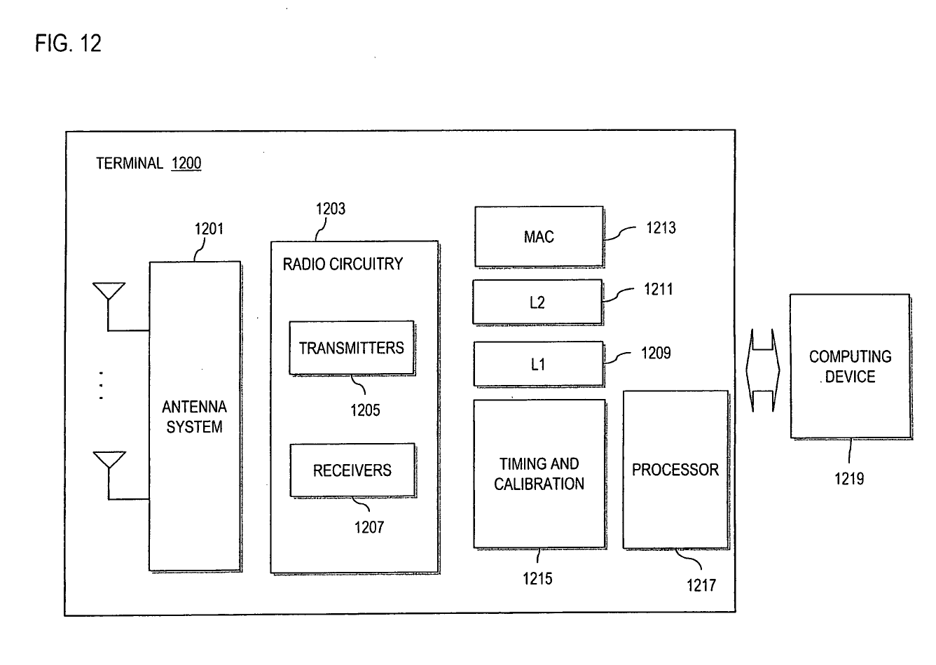

FIG. 12 is a diagram of exemplary components of a user terminal configured to operate in the systems of FIGS. 10A-10D, according to an embodiment of the invention. A user terminal 1200 includes an antenna system 1201 (which can utilize multiple antennas) to receive and transmit signals. The antenna system 1201 is coupled to radio circuitry 1203, which includes multiple transmitters 1205 and receivers 1207. The radio circuitry encompasses all of the Radio Frequency (RF) circuitry as well as base-band processing circuitry. As shown, layer-1 (L1) and layer-2 (L2) processing are provided by units 1209 and 1211, respectively. Optionally, layer-3 functions can be provided (not shown). Module 1213 executes all Medium Access Control (MAC) layer functions. A timing and calibration module 1215 maintains proper timing by interfacing, for example, an external timing reference (not shown). Additionally, a processor 1217 is included. Under this scenario, the user terminal 1200 communicates with a computing device 1219, which can be a personal computer, work station, a Personal Digital Assistant (PDA), web appliance, cellular phone, etc.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining number of system information windows to be transmitted during a longest one of a plurality of repetition periods;
determining number of system information windows corresponding to a shortest one of the repetition periods within the determined longest repetition period; and
determining average amount of the system information windows based on the determined shortest repetition period and one or more available transmission periods associated with a communication channel of a network,
wherein system information is scheduled for transmission over the communication channel according to the determined average of system information windows.

2. A method according to claim 1, wherein the repetition rate specifying frequency of transmission of the system information to a terminal over the network.

3. A method according to claim 1, wherein one or more of the system information windows are delayed, the method further comprising:
assigning the delayed system information windows a higher priority than other remaining ones of the system information windows.

4. A method according to claim 1, wherein the system information is sent over a downlink shared channel to the terminal.

5. A method according to claim 1, wherein the system information includes a system information block (SIB).

6. A method according to claim 1, wherein the system information is concurrently transmitted over the communication channel with physical resource blocks (PRBs).

7. A computer-readable storage medium carrying one or more sequences of one or more instructions which, when executed by one or more processors, cause the one or more processors to perform the method of claim 1.

8. An apparatus comprising:
logic configured to determine number of system information windows to be transmitted during a longest one of a plurality of repetition periods, and to determine number of system information windows corresponding to a shortest one of the repetition periods within the determined longest repetition period,
wherein the logic is further configured to determine average amount of the system information windows based on the determined shortest repetition period and one or more available transmission periods associated with a communication channel of a network,
wherein system information is scheduled for transmission over the communication channel according to the determined average of system information windows.

9. An apparatus according to claim 8, wherein the repetition rate specifying frequency of transmission of the system information to a terminal over a network.

10. An apparatus according to claim 8, wherein one or more of the system information windows are delayed, and the logic is further configured to assign the delayed system information windows a higher priority than other remaining ones of the system information windows.

11. An apparatus according to claim 8, wherein the system information is sent over a downlink shared channel to the terminal.

12. An apparatus according to claim 8, wherein the system information includes a system information block (SIB).

13. An apparatus according to claim 8, wherein the system information is concurrently transmitted over the communication channel with physical resource blocks (PRBs).

14. A method comprising:
determining an overflow condition associated with one of a plurality of system information windows, wherein the overflow condition exists if the one system information window extends to an adjacent transmission period;
determining a next available slot within a communication channel; and
assigning the one system information window in the overflow condition to the next available slot.

15. A method according to claim 14, wherein the system information is transmitted according to a repetition rate that specifies frequency of transmission of the system information to a terminal over the network.

16. A method according to claim 14, wherein the system information is sent over a downlink shared channel to the terminal.

17. A method according to claim 14, wherein the system information includes a system information block (SIB).

18. A method according to claim 14, wherein the system information is concurrently transmitted over the communication channel with physical resource blocks (PRBs).

19. A computer-readable storage medium carrying one or more sequences of one or more instructions which, when executed by one or more processors, cause the one or more processors to perform the method of claim 14.

20. An apparatus comprising:
logic configured to determine an overflow condition associated with one of a plurality of system information windows, wherein the overflow condition exists if the one system information window extends to an adjacent transmission period,
wherein the logic is further configured to determine a next available slot within a communication channel, and to assign the one system information window in the overflow condition to the next available slot.

21. An apparatus according to claim 20, wherein the system information is transmitted according to a repetition rate that specifies frequency of transmission of the system information to a terminal over the network.

22. An apparatus according to claim 20, wherein the system information is sent over a downlink shared channel to the terminal.

23. An apparatus according to claim 20, wherein the system information includes a system information block (SIB).

24. An apparatus according to claim 20, wherein the system information is concurrently transmitted over the communication channel with physical resource blocks (PRBs).
